(19) United States
(12) Patent Application Publication
(10) Pub. No.: US 2025/0322526 A1
(43) Pub. Date: Oct. 16, 2025

(54) METHOD AND DEVICE FOR CREATING A MASK FOR SEGMENTING AT LEAST ONE TEST IMAGE

(71) Applicant: Robert Bosch GmbH, Stuttgart (DE)

(72) Inventors: Clint Sebastian, Stuttgart (DE); Keng Chai, Stuttgart (DE)

(21) Appl. No.: 19/173,867

(22) Filed: Apr. 9, 2025

(30) Foreign Application Priority Data
Apr. 15, 2024 (DE) 10 2024 203 468.1

(51) Int. Cl. G06T 7/10; G06V 10/25; G06V 10/44

(52) U.S. Cl. CPC G06T 7/10; G06V 10/25; G06V 10/44

(57) ABSTRACT

A method for creating a mask for segmenting at least one test image. The method includes: providing a masked query image; creating a concept embedding by extracting coding features from the masked query image using a generic segmentation model; creating a test embedding by extracting coding features from the test image by means of the generic segmentation model; multiplying the concept embedding and the test embedding to obtain an attention mask; creating an initial mask for the test image using the generic segmentation model based on the attention mask, an item of position information derived from the attention mask, and the test embedding; extracting a bounding box from the created initial mask; and creating the mask for the test image using the generic segmentation model based on the attention mask, the extracted bounding box, and the test embedding for segmenting at least one test image.

### CROSS REFERENCE

The present application claims the benefit under 35 U.S.C. § 119 of German Patent Application No. DE 10 2024 203 468.1 filed on Apr. 15, 2024, which is expressly incorporated herein by reference its entirety.

### FIELD

The present invention relates to a method and to a device for creating a mask for segmenting at least one test image.

### BACKGROUND INFORMATION

Unsupervised segmentation is a challenge in the field of computer vision, in particular if the semantics or meaning behind the image elements is not available.

This task requires an algorithm that identifies and delimits different segments within an image without prior knowledge or labels by human annotators being present. Among the countless methods that attempt to address this challenge, Segment Anything is one solution.

This unsupervised segmentation method is characterized by its ability to analyze data clusters in order to create precise masks that define the boundaries of the different segments. One advantage of Segment Anything is its ability to create high-quality segmentations with clear boundaries, which increases its applicability in different domains. In addition, it offers the possibility to control the segmentation process through inputs such as a point or a bounding box and thus to tailor the generated masks to specific requirements.

Despite its impressive performance, Segment Anything has limitations when it comes to recognizing the semantics within the segmented regions. This shortcoming is critical especially in the manufacturing sector, where understanding the semantics of each segment is crucial for accurate measurements and/or quality control. While Segment Anything (also SAM) sets a high standard for unsupervised segmentation, the search for semantic understanding within this framework remains an area for further development.

It is an object of the present invention to provide an optimized method and/or an optimized device in this respect.

The object may be achieved by a method and a device according to example embodiments of the present invention.

### SUMMARY

According to a first aspect of the present invention, a method for creating a mask for segmenting at least one test image is provided. According to an example embodiment of the present invention, the method comprises the following steps:
providing at least one masked query image;
creating a concept embedding by extracting coding features from the at least one masked query image by means of a generic segmentation model;
creating a test embedding by extracting coding features from the at least one test image by means of the generic segmentation model;
multiplying the concept embedding and the test embedding to obtain an attention mask;
creating an initial mask for the at least one test image by means of the generic segmentation model on the basis of the attention mask, an item of position information derived from the attention mask, and the test embedding;
extracting a bounding box from the created initial mask; and
creating the mask for the at least one test image by means of the generic segmentation model on the basis of the attention mask, the extracted bounding box, and the test embedding for segmenting at least one test image.

It is understood that the steps according to the present invention as well as other optional steps do not necessarily have to be carried out in the order shown, but can also be carried out in a different order. Other intermediate steps can also be provided.

The individual steps can also comprise one or more sub-steps without departing from the scope of the method according to the present invention.

According to a second aspect of the present invention, a device for creating a mask for segmenting at least one test image is provided. According to an example embodiment of the present invention, the device comprises an evaluation and computing unit which is designed to carry out the following steps:
providing at least one masked query image;
creating a concept embedding by extracting coding features from the at least one masked query image by means of a generic segmentation model;
creating a test embedding by extracting coding features from the at least one test image by means of the generic segmentation model;
multiplying the concept embedding and the test embedding to obtain an attention mask;
creating an initial mask for the at least one test image by means of the generic segmentation model on the basis of the attention mask, an item of position information derived from the attention mask, and the test embedding, wherein the initial mask forms a first estimate of the mask/segmentation mask;
extracting a bounding box from the created initial mask; and
creating the mask for the at least one test image by means of the generic segmentation model on the basis of the attention mask, the extracted bounding box, and the test embedding for segmenting at least one test image in order to refine the final results of segmentation.

The explanations given for the method of the present invention apply accordingly to the device of the present invention. It is understood that linguistic modifications of features formulated for the method can be reformulated for the device in accordance with standard linguistic practice, without such formulations having to be explicitly listed here.

The present method enables a user to select a specific defect and/or product type, in particular using a mask, and to find an area of interest in an image database without the need for any form of training. The present method therefore constitutes a so-called zero-shot approach. This is advantageous for obtaining a segmentation mask and/or creating a mask for segmenting image data and/or image data content in a short time (for example, within minutes instead of hours) for training a neural network (for example, a CNN).

It involves selecting a region of interest in an image or set of images using a prompt such as a mask. Subsequently, similarity searches are carried out within the dataset on the basis of the prompt in order thus to find an identical (search) object in the dataset. After the initial search results, the prompt may be further refined by post-processing, for example by means of SAM.

A common example in automated optical inspection (AOI) is the detection of a defect in relation to an (image) background. Here, the defect can be understood as the “concept” (see concept embedding). This concept can be extended to multiple classes by changing the mask that is paired with the query image. Multiple concepts could represent different error types, defects and/or product types, etc.

“Providing at least one masked query image” is a step in which one or more masked images are provided. These images serve as the basis for the further method in that they are used as a comparison basis for segmentation. A so-called concept embedding is created by extracting coding features from the masked query image by means of a generic segmentation model. This embedding represents the essential features of the query image in a compressed data format. Similarly to concept embedding, coding features are extracted from the test image in order to create a test embedding. This embedding represents the features of the test image to be segmented. An attention mask is generated by multiplying the concept embedding by the test embedding. This mask serves to identify relevant areas in the test image that are important for segmentation. An initial mask for the test image is created on the basis of the attention mask, the derived position information from said mask, and the test embedding. Said initial mask forms a preliminary segmentation attempt that highlights specific areas of the image. A bounding box is extracted from the created initial mask. This box frames the relevant area of the image that is important for the final segmentation. The final mask is created using the attention mask, the extracted bounding box, and the test embedding. Said mask is then used to segment the test image, i.e., specific parts of the image are isolated on the basis of the previously ascertained features and areas. The use of embeddings and attention masks allows an analysis of relevant image areas, which improves the accuracy of segmentation.

In a further aspect of the present invention, providing the at least one masked query image comprises multiplying, in particular in an element-wise or pixel-wise manner, a provided mask by at least one provided query image.

The aspect of the present invention describes performing a multiplication at the level of individual elements or pixels between a provided mask and one or more query images. Element-wise multiplication means that each pixel of the mask is multiplied by the corresponding pixel of the query image. The result is a new image, in which the intensity of each pixel is determined by the product of the corresponding values in the mask and in the query image. The provided mask is a data structure that serves to highlight or suppress certain areas of the query image. Preferably, the mask contains values between 0 and 1 (or 0 and 255, depending on the format), wherein a value of 0 means that the corresponding pixel in the query image is ignored (or considered irrelevant) in the further processing, while a value of 1 (or 255) means that the pixel is fully considered. The query images are used together with the provided mask to generate the masked query images used in the subsequent steps of the method. This allows data preparation by masking out areas and drawing attention to the features that are important for segmentation.

In a further aspect of the present invention, the generic segmentation model comprises a Segment Anything Model or an Efficient Segment Anything Model.

The Segment Anything Model is designed to segment a wide range of objects in images, regardless of their category. It aims to identify and segment objects in the image without specific pre-training on certain object classes. SAM has a high generalization ability, which means that it can be effectively applied to new, unknown image data without the need for extensive readjustment or retraining.

The Efficient Segment Anything Model builds on the Segment Anything Model, with a special focus on efficiency. It is designed to optimize resource usage (such as computation time and memory requirements) without significantly impacting segmentation performance. It includes in particular improvements and optimizations that make it possible to process images faster. This can be achieved through lightweight network architectures, improved image preprocessing algorithms, and more efficient data flow mechanisms. The Efficient Segment Anything Model is particularly suitable for applications in which fast processing times and efficient resource utilization are critical without neglecting segmentation accuracy.

In a further aspect of the present invention, concept embedding and/or test embedding is generated by a mean over embeddings of the at least one query image and/or by a mean over embeddings of the at least one test image.

Concept embedding, which represents the essential features of the query image(s), is preferably generated by calculating the average (mean) of the embeddings of these query images. This means that, if multiple query images are present, their embeddings are first calculated individually. The average value of these embeddings is then taken to create a single, aggregated concept embedding. This method aims to extract the common features of the query images and combine them into a single embedding. Similarly to concept embedding, test embedding, which represents the essential features of the test image(s), can be generated by calculating the average of the embeddings of these test images. If multiple test images are analyzed, a representative embedding that reflects the general features of all test images can thus be created. By averaging over multiple embeddings, specific deviations or anomalies in individual images can be smoothed out, resulting in an embedding that better represents the essential and recurring features of the image group.

In a further aspect of the present invention, multiplying the concept embedding and the test embedding to obtain the attention mask comprises calculating a cosine similarity between the concept embedding and the test embedding, wherein the attention mask preferably corresponds to a similarity matrix normalized between 0 and 1.

Cosine similarity is a measure of the similarity between two vectors in multidimensional space that is independent of their size. Cosine similarity is determined by the cosine of the angle between the two vectors, wherein values close to 1 indicate high similarity (small angle) and values close to 0 indicate low similarity (angle close to 90 degrees). The results of the cosine similarity calculation are preferably used to create a similarity matrix. Said matrix serves as an attention mask indicating how similar each element (e.g., pixel or feature) of concept embedding is compared to each element of test embedding.

The similarity matrix is preferably normalized such that its values are between 0 and 1. This normalization is important in order to ensure a consistent interpretation of the similarity values and to be able to use them directly as attention values in the segmentation task. By using cosine similarity to create the attention mask, the system is trained to focus on the features that are similar in both embeddings (concept and test). This improves the system's ability to identify relevant areas in the test image for segmentation. Attention mask normalization makes precise control of segmentation possible by ensuring that attention is distributed proportionally to the similarity between the concept image and test image. This can lead to higher segmentation accuracy, in particular in scenarios where the objects or features to be segmented are subtle or complex.

In a further aspect of the present invention, the position information derived from the attention mask is provided by selecting a position of a point with highest activation and of a point with lowest activation, wherein the highest activation is found in a foreground of the at least one test image and the lowest activation is found in a background of the at least one test image. The position with the highest activation is preferably found in the foreground of the test image. This means that the point with highest activation represents the area of the image that is considered particularly relevant for the segmentation task since it contains significant features or objects. Analogously, the position with lowest activation is identified in the background of the test image. This point represents areas considered to be least relevant for the segmentation task and therefore likely to contain background elements without significant features. The accuracy of segmentation can be improved by identifying the points with highest and lowest activation and assigning them to the foreground or background of the image. This targeted identification helps to distinguish between relevant and irrelevant image areas, which forms the basis for effective mask creation. The selection of these specific points helps the system to differentiate objects in the foreground from the background.

This is particularly useful in complex scenes where the delimitation between foreground and background is not immediately obvious.

In a further aspect of the present invention, the present method is used in automated optical inspection and/or optical security monitoring.

Automated optical inspection is an important process in the manufacturing industry that automates visual inspection procedures in order to check products or components for quality or specific defects. AOI systems are used, for example, in electronics manufacturing to check printed circuit boards (PCBs), solder joints, and other critical components for defects. The described segmentation method can be used in AOI systems to precisely analyze images of products or components. By creating specific masks, the system can exactly identify the areas that need to be examined for possible defects or quality issues. The ability to segment and analyze fine details is important for quality assurance and minimizing error rates. Optical security monitoring involves the use of monitoring technologies to secure property, protect people, and monitor critical infrastructures. This may include the use of cameras, sensors, and other optical systems to detect unwanted activity or security threats. In optical security monitoring, the method can be used to improve the detection and differentiation between normal and potentially threatening situations. Segmenting people, vehicles, or other objects of interest from the background and analyzing their behavior or movement patterns can help to respond quickly to security threats.

In AOI applications, it is common for customers not to have a segmentation mask associated with the dataset, which can be a hindrance when training a segmentation model. This deficiency can be remedied by the present method. For example, the method can be used to quickly segment a (new) defect without a mask being known beforehand. The customer/user can provide only a query image and a corresponding mask of a defect for this purpose. The proposed approach can be used to segment/locate a defect without a segmentation model having been explicitly trained for this purpose. Even if segmentation may not be perfect, it is still sufficiently accurate to serve the customer/user as a starting point for marking a (new) defect.

In a further aspect of the present invention, a control unit is also provided, which is included in a vehicle having an autonomous driving function, and/or a robotic system and/or an industrial machine and on which the method of the present invention can be carried out in one of its aspects.

In a further aspect of the present invention, a computer program having program code is provided for executing at least parts of the method of the present invention in one of its aspects when the computer program is executed on a computer. In other words, a computer program (product) comprising instructions which, when the program is executed by a computer, cause the computer to execute the method/the steps of the method in one of its aspects.

In a further aspect of the present invention, a computer-readable medium having program code of a computer program is proposed for executing at least parts of the present method in one of its aspects when the computer program is executed on a computer. In other words, the present invention relates to a computer-readable (memory) medium comprising instructions which, when executed by a computer, cause the computer to execute the method/the steps of the method in one of its aspects.

The described embodiments and developments of the present invention can be combined with one another as desired.

Further possible embodiments, developments, and implementations of the present invention also include combinations not explicitly mentioned of features of the present invention described above or in the following relating to the exemplary embodiments of the present invention.

### BRIEF DESCRIPTION OF THE DRAWINGS

The figures are intended to impart further understanding of embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a schematic flow chart of a method according to an example embodiment of the present invention.

FIG. 2 is a schematic block diagram of the method according to an example embodiment of the present invention.

In the figures, identical reference signs denote identical or functionally identical elements, parts or components, unless stated otherwise.

### DETAILED DESCRIPTION OF EXAMPLE EMBODIMENTS

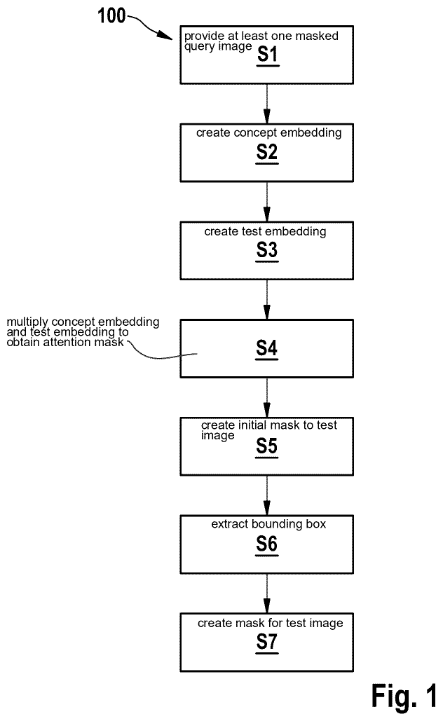

FIG. 1 shows a schematic flow chart of a method for creating a mask for segmenting at least one test image.

In any embodiment, the method can be carried out, at least in part, by a device 100, which for this purpose can comprise multiple components not shown in more detail, for example one or more provisioning units and/or at least one evaluation and computing unit. It is self-evident that the provisioning unit can be designed together with the evaluation and computing unit or can be different therefrom. Furthermore, the device 100, which can be part of a system, can comprise a storage unit and/or an output unit and/or a display unit and/or an input unit.

The computer-implemented method comprises at least the following steps:

In a step S1, at least one masked query image is provided.

Providing S1 the at least one masked query image preferably comprises multiplying, in particular in an element-wise or pixel-wise manner, a provided mask by at least one provided query image.

In a step S2, a concept embedding is created by extracting coding features from the at least one masked query image by means of a generic segmentation model. The generic segmentation model includes a Segment Anything Model or an Efficient Segment Anything Model. Extraction is preferably performed by a SAM encoder.

In a step S3, a test embedding is created by extracting coding features from the at least one test image by means of the generic segmentation model. The generic segmentation model includes a Segment Anything Model or an Efficient Segment Anything Model. Extraction is preferably performed by a SAM encoder.

In a step S4, the concept embedding and the test embedding are multiplied to obtain an attention mask. Multiplying the concept embedding and the test embedding to obtain the attention mask preferably comprises calculating a cosine similarity between the concept embedding and the test embedding, wherein the attention mask preferably corresponds to a similarity matrix normalized between 0 and 1.

In a step S5, an initial mask for the at least one test image is created by means of the generic segmentation model on the basis of the attention mask, an item of position information derived from the attention mask, and the test embedding. The position information derived from the attention mask is provided by selecting a position of a point with highest activation and of a point with lowest activation, wherein the highest activation is found in a foreground of the at least one test image and the lowest activation is found in a background of the at least one test image. The initial mask is preferably created by a SAM decoder.

In a step S6, a bounding box is extracted from the created initial mask.

In a step S7, the mask for the at least one test image is created by means of the generic segmentation model on the basis of the attention mask, the extracted bounding box, and the test embedding for segmenting at least one test image. The mask is preferably created by a SAM decoder.

The mask or the final mask can be used to segment the unmasked test image without the need for retraining. The mask provided by the method is refined, in particular by the twofold creation of a mask, so that segmentation can be carried out with high precision. This is in particular advantageous for automated optical inspection but also for security monitoring.

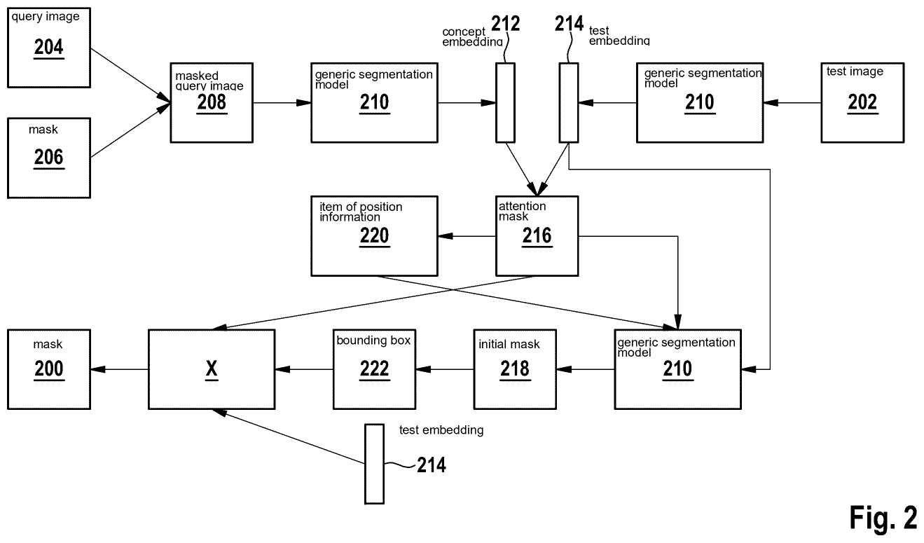

FIG. 2 shows a schematic block diagram of the present method for creating a mask 200 for segmenting at least one test image 202. At least one query image 204 is provided, which is masked by applying a mask 206. The masked query image is denoted by 208. A generic segmentation model 210, in particular a SAM encoder included therein, creates a concept embedding 212 by extracting coding features from the at least one masked query image 208. The generic segmentation model 210, in particular the SAM encoder included therein, further creates a test embedding 214 by extracting coding features from the at least one test image 202. Concept embedding 212 and test embedding 214 are multiplied in order to obtain an attention mask 216 in this way. An initial mask 218 for the at least one test image 202 is created by means of the generic segmentation model 210, in particular by a SAM decoder included therein. This is done on the basis of the attention mask 216, an item of position information 220 derived from the attention mask 216, and the test embedding 214. A bounding box 222 (x1, y1, x2, y2) is extracted from the created initial mask 218. The mask 200 for the at least one test image 202 is ultimately generated by re-applying the generic segmentation model 210, in particular by the SAM decoder included therein, on the basis of the attention mask 216, the extracted bounding box 222, and the test embedding 214.

The mask 200 generated in this way is then preferably used to segment the at least one test image 202.

What is claimed is:

1. A method for creating a mask for segmenting at least one test image, the method comprising the following steps:
providing at least one masked query image;
creating a concept embedding by extracting coding features from the at least one masked query image using a generic segmentation model;
creating a test embedding by extracting coding features from the at least one test image using the generic segmentation model;
multiplying the concept embedding and the test embedding to obtain an attention mask;
creating an initial mask for the at least one test image using the generic segmentation model based on the attention mask, an item of position information derived from the attention mask, and the test embedding;
extracting a bounding box from the created initial mask; and
creating the mask for the at least one test image using the generic segmentation model based on the attention mask, the extracted bounding box, and the test embedding, for segmenting at least one test image.

2. The method according to claim 1, wherein the providing of the at least one masked query image includes multiplying, in an element-wise or pixel-wise manner, a provided mask by at least one provided query image.

3. The method according to claim 1, wherein the generic segmentation model includes a Segment Anything Model or an Efficient Segment Anything Model.

4. The method according to claim 1, wherein the concept embedding and/or the test embedding is generated by a mean over embeddings of the at least one query image and/or by a mean over embeddings of the at least one test image.

5. The method according to claim 1, wherein multiplying the concept embedding and the test embedding to obtain the attention mask includes calculating a cosine similarity between the concept embedding and the test embedding, wherein the attention mask corresponds to a similarity matrix normalized between 0 and 1.

6. The method according to claim 1, wherein the position information derived from the attention mask is provided by selecting a position of a point with highest activation and of a point with lowest activation, wherein the highest activation is found in a foreground of the at least one test image and the lowest activation is found in a background of the at least one test image.

7. The method according to claim 1, wherein the method is used in automated optical inspection.

8. A non-transitory computer-readable data carrier on which are stored program code of a computer program for creating a mask for segmenting at least one test image, the program code, when executed by a computer, causing the computer to perform the following steps:
providing at least one masked query image;
creating a concept embedding by extracting coding features from the at least one masked query image using a generic segmentation model;
creating a test embedding by extracting coding features from the at least one test image using the generic segmentation model;
multiplying the concept embedding and the test embedding to obtain an attention mask;
creating an initial mask for the at least one test image using the generic segmentation model based on the attention mask, an item of position information derived from the attention mask, and the test embedding;
extracting a bounding box from the created initial mask; and
creating the mask for the at least one test image using the generic segmentation model based on the attention mask, the extracted bounding box, and the test embedding, for segmenting at least one test image.

9. A device configured to create a mask for segmenting at least one test image, the device comprising:
an evaluation and computing unit configured to:
provide at least one masked query image,
create a concept embedding by extracting coding features from the at least one masked query image using a generic segmentation model,
create a test embedding by extracting coding features from the at least one test image using the generic segmentation model,
multiply the concept embedding and the test embedding to obtain an attention mask,
create an initial mask for the at least one test image using the generic segmentation model based on the attention mask, an item of position information derived from the attention mask, and the test embedding,
extract a bounding box from the created initial mask, and
create the mask for the at least one test image using the generic segmentation model based on the attention mask, the extracted bounding box, and the test embedding, for segmenting at least one test image.
